(19) United States
(12) Patent Application Publication
(10) Pub. No.: US 2016/0282966 A1
(43) Pub. Date: Sep. 29, 2016

(54) INPUT DEVICES AND METHODS

(71) Applicant: uHDevice Electronics Jiangsu Co., Ltd., Shanghai (CN)

(72) Inventors: Jian LIU, Shanghai (CN); Eric Yik-nam KWOK, Santa Clara, CA (US); Wenfu LI, Shanghai (CN)

(73) Assignee: uHDevice Electronics Jiangsu Co., Ltd., Shanghai (CN)

(21) Appl. No.: 14/868,383

(22) Filed: Sep. 28, 2015

(30) Foreign Application Priority Data
Mar. 23, 2015 (CN) 201510128947.5
Apr. 30, 2015 (CN) 201510219024.0
May 18, 2015 (CN) 201510254848.1
Jun. 5, 2015 (CN) 201510307311.7

(51) Int. Cl. G06F 3/038; G06F 3/041; G06F 3/01; G06F 3/0354

(52) U.S. Cl. CPC G06F 3/0383; G06F 3/03543; G06F 3/03547; G06F 3/03549; G06F 3/041; G06F 3/017

(57) ABSTRACT

A mouse for use with a computer is disclosed. According to certain embodiments, the mouse includes one or more sensors configured to detect a user action on the mouse. The mouse also includes a command generator configured to transmit signals to the computer. The signals cause the computer to determine a predefined destination in response to the user action. Information of the predefined destination is editable. The signals also cause the computer to present information at the predefined destination to the user.

### TECHNICAL FIELD

The present disclosure generally relates to the field of computer technology and, more particularly, to input devices and methods.

### BACKGROUND

Input devices are essential for computer technology. Many types of input devices, such as mice, track balls, remote controls, touch screens, touch pads, etc., have been developed to input data and user commands into an electronic device in various configurations. However, these input devices are designed to only provide one-way information flow from a user to the electronic device. Such rigid usage limits the input devices' value in human-machine interaction, and also prevents other people from interacting with the user through the input device.

Moreover, conventionally the user may have to use multiple input devices and take multiple steps to complete an operation. For example, to visit a webpage, the user needs to first use a mouse to open an Internet browser, and then use a keyboard to type the uniform resource locator (URL) of the webpage in the browser's address bar. This complicated procedure can be cumbersome for some routinely used operations.

### SUMMARY

According to a first aspect of the present disclosure, there is provided a mouse for use with a computer. The mouse includes one or more sensors configured to detect a user action on the mouse. The mouse also includes a command generator configured to transmit signals to the computer. The signals cause the computer to determine a predefined destination in response to the user action. Information of the predefined destination is editable. The signals also cause the computer to present information at the predefined destination to the user.

According to a second aspect of the present disclosure, there is provided a mouse for accessing a predefined destination in a click-less way. The mouse includes one or more sensors configured to detect a motion of the mouse. The mouse also includes a command generator configured to transmit signals to a computer. The signals cause the computer to access the predefined destination. Neither clicking on the mouse nor typing an address of the predefined destination is required to access the predefined destination.

According to a third aspect of the present disclosure, there is provided an input device for use with an electronic device. The input device includes one or more sensors configured to detect a user action. The input device also includes a command generator configured to transmit signals to the electronic device. The signals initiate a determination of a predefined response to the user action. Information of the predefined response is stored in a routing table. The signals also cause the electronic device to present the predefined response to the user.

According to a fourth aspect of the present disclosure, there is provided an input device for use with an electronic device. The input device includes one or more sensors configured to detect a motion of the input device. The input device also includes a decision maker configured to compare the detected motion with a threshold condition. The input device further includes a command generator configured to, if a result of the comparison meets predefined criteria, generate signals cause the electronic device to connect to a predefined destination.

According to a fifth aspect of the present disclosure, there is provided a method of an input device in communication with an electronic device. The method includes detecting a user action. The method also includes initiating a determination of a predefined response to the user action. Information of the predefined response is stored in a routing table. The method further includes causing the electronic device to present the predefined response to the user.

According to a sixth aspect of the present disclosure, there is provided a method of an input device in communication with an electronic device. The method includes detecting a motion of the input device. The method also includes comparing the detected motion with a threshold condition. The method further if a result of the comparison meets predefined criteria, connecting to a predefined destination.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating a system for implement an input method, according to an exemplary embodiment.

FIG. 2 is a block diagram of system for implementing an input method, according to an exemplary embodiment.

FIG. 3 is a flowchart of an input method, according to an exemplary embodiment.

FIG. 4 is a schematic diagram illustrating an implementation of an input method, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

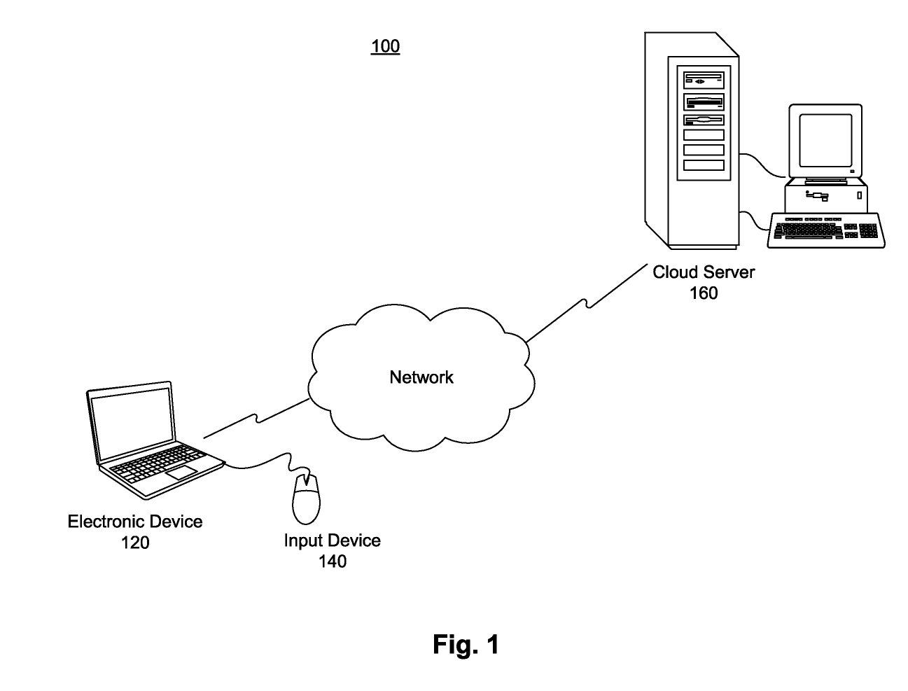

FIG. 1 is a schematic diagram illustrating a system 100 for implementing an input method, according to an exemplary embodiment. Referring to FIG. 1, the system 100 includes an electronic device 120, and an input device 140 connected to the electronic device 120. In some embodiments, the system 100 further includes a cloud sever 160 communicating with the electronic device 120 via a network.

The electronic device 120 has computing power or is otherwise capable of performing tasks based on data and command signals received from the input device 140. For example, the electronic device 120 may be a computer, a tablet, a smart phone, a smart TV, a personal digital assistant, etc.

The input device 140 is configured to provide data and control signals to the electronic device 120. The input device 140 may have an ID assigned by the manufacturer. For example, the input device 140 may be a mouse, a remote control, a touch pad, a touch screen, a track ball, a human gesture recognition device (e.g., a camera configured to recognize hand gestures and/or shapes), etc.

The cloud server 160 may be a general purpose computer, a mainframe computer, or any combination of these components. The cloud server 160 may be implemented as a server, a server cluster consisting of a plurality of servers, or a cloud computing service center. The cloud server 160 may be operated by a third party service provider, or a manufacturer or a seller of the input device 140. The cloud server 160 may also have one or more input devices that allow the operator to enter data and to run tasks on the cloud server 160.

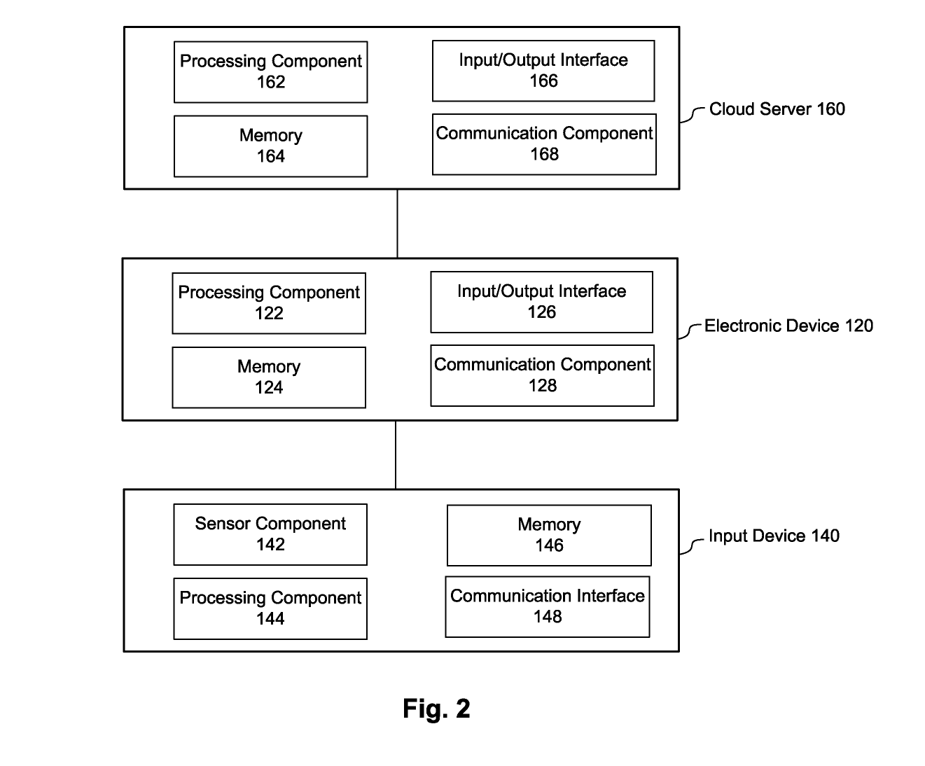

FIG. 2 is a block diagram of the system 100 illustrated in FIG. 1, according to an exemplary embodiment. Referring to FIG. 2, the illustrated electronic device 120 includes one or more of the following components: a processing component 122, a memory 124, an input/output (I/O) interface 126, and a communication component 128. Electronic device 120 may also include one or more of a power component and a multimedia component (not shown).

The processing component 122 may control overall operations of the electronic device 120. For example, processing component 122 may include one or more processors that execute instructions to perform all or part of the steps in the following described methods. Moreover, the processing component 122 may include one or more modules which facilitate the interaction between the processing component 122 and other components. For instance, the processing component 122 may include an I/O module to facilitate the interaction between the I/O interface and the processing component 122.

Memory 124 is configured to store various types of data and/or instructions to support the operation of the electronic device 120. The memory 124 may include a non-transitory computer-readable storage medium including instructions for applications or methods operated on the electronic device 120, executable by the one or more processors of the electronic device 120. For example, the non-transitory computer-readable storage medium may be a read-only memory (ROM), a random access memory (RAM), a CD-ROM, a magnetic tape, a memory chip (or integrated circuit), a hard disc, a floppy disc, an optical data storage device, or the like.

The I/O interface 126 provides an interface between the processing component 122 and peripheral interface modules, such as the input device 140 and other input and output devices. The I/O interface 126 may employ communication protocols/methods such as audio, analog, digital, serial bus, universal serial bus (USB), infrared, PS/2, BNC, coaxial, RF antennas, Bluetooth, etc. For example, the I/O interface 126 may receive from the input device 140 a control signal, e.g., accessing the cloud server 160, and send the control command to the processing command 122 for further processing.

The communication component 128 is configured to facilitate communication, wired or wirelessly, between the electronic device 120 and other devices, such as devices connected to the Internet. The electronic device 120 can access a wireless network based on one or more communication standards, such as WiFi, LTE, 2G, 3G, 4G, 5G, etc. In one exemplary embodiment, the communication component 128 includes a near field communication (NFC) module to facilitate short-range communications between the electronic device 120 and devices like the input device 140. In other embodiments, the communication component 128 may be implemented based on a radio frequency identification (RFID) technology, an infrared data association (IrDA) technology, an ultra-wideband (UWB) technology, a Bluetooth (BT) technology, or other technologies.

Referring to FIG. 2, the illustrated input device 140 includes the following components: a sensor component 142, a processing component 144, a memory 146, and a communication interface 148.

The sensor component 142 may include one or more sensors to provide status assessments of various aspects of the input device 140. For instance, the sensor component 142 may detect a change in position of the input device 140, a presence or absence of user contact with the input device 140, an orientation or an acceleration/deceleration of the input device 140, and a change in temperature of the input device 140. The sensor component 142 may include a proximity sensor configured to detect the presence of nearby objects without any physical contact. The sensor component 142 may also include a light sensor, such as a CMOS or CCD image sensor, for use in imaging applications. In some embodiments, the sensor component 142 may also include an accelerometer, a gyroscope, a magnetic sensor, a pressure sensor, or a temperature sensor.

For example, the input device 140 may be an optical mouse that includes a CMOS image sensor capable of detecting light reflected from a physical surface on which the mouse is moving. The mouse may also include a pressure sensor, touch sensor, or switch, etc., capable of detecting a user's clicking on a button of the mouse.

For another example, the input device 140 may be a touch screen or a touch pad that includes one or more touch sensors to sense touches, swipes, and gestures on the touch panel. The touch sensors may not only sense a boundary of a touch or swipe action, but also sense a period of time and a pressure associated with the touch or swipe action.

In some embodiments, the sensor component 142 is configured to compare the detected signals with one or more conditions. If the comparison meets preset criteria, the sensor component 142 may send the signals to the processing component 144 or the electronic device 120 for further processing. If not, the sensor component 142 may reject the signals. For example, the sensor component 142 may include one or more gate devices to only accept light or voltage signals that exceed certain levels.

The processing component 144 includes one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing all or part of the steps in the following described methods.

For example, the processing component 144 may be configured to determine motion parameters associated with the status of the input device 140 based on signals received from the sensor component. Depending on the type of the input device 140, the motion parameters may be configured to describe the motion of a mouse or a remote control, the motion of a finger or a pen on the surface of a touch pad or a touch screen, rotation of a track ball, absolute and relative motions of figures of a hand, etc. The motion parameters may include moving speed, acceleration, deceleration, moving direction, moving trajectory (e.g., circles or triangles), moving frequency (e.g., moving in certain direction for multiple times in a given time period, or swinging between different directions for multiple times in a given time period), or any combination thereof.

As another example, in the case of a mouse, the processing component 144, through a built-in timer, may be configured to determine the time period during which a button is clicked, a frequency at which the button is clicked during a given time, the time interval between two successive clicking events on the same button, etc. Moreover, the processing component 144 may be configured to determine a pattern of clicking a combination of multiple buttons, e.g., sequentially left clicking, or right clicking followed by left clicking within a certain time period.

The memory 146 may be a flash memory configured to store data and/or instructions to support the operation of the input device 140. For example, the memory 146 may store the data and/or instructions used by the processing component 144 of the input device 140 to perform all or part of the steps in the following described methods. Moreover, the memory 146 may store the ID of the input device 140.

The communication interface 148 is configured to provide wired or wireless connection to the electronic device 120. For example, in the case of a mouse, the mouse may be connected to the electronic device 120 by an electric cord. Alternatively, the mouse may include a radio frequency transmitter to transmit wireless signals to the electronic device 120 through, e.g., a wireless USB receiver plugged into the electronic device 120 or a Bluetooth antenna carried by the electronic device 120. In another embodiment, an input device 140, such as a touch pad or touch screen, may be built into the electronic device 120.

Referring to FIG. 2, the cloud server 160 may include one or more of a processing component 162, a memory 164, an I/O interface 166, and a communication component 168, similar to the processing component 122, the memory 124, the I/O interface 126, and the communication component 128.

For illustration purposes only, the following description assumes the input device 140 to be a computer mouse. A user can move and/or click the mouse to provide input to and control functions of the electronic device 120. But those skilled in the art will appreciate the present disclosure is not limited to a mouse. The methods and systems provided in the present disclosure can be adapted to other types of input devices 140.

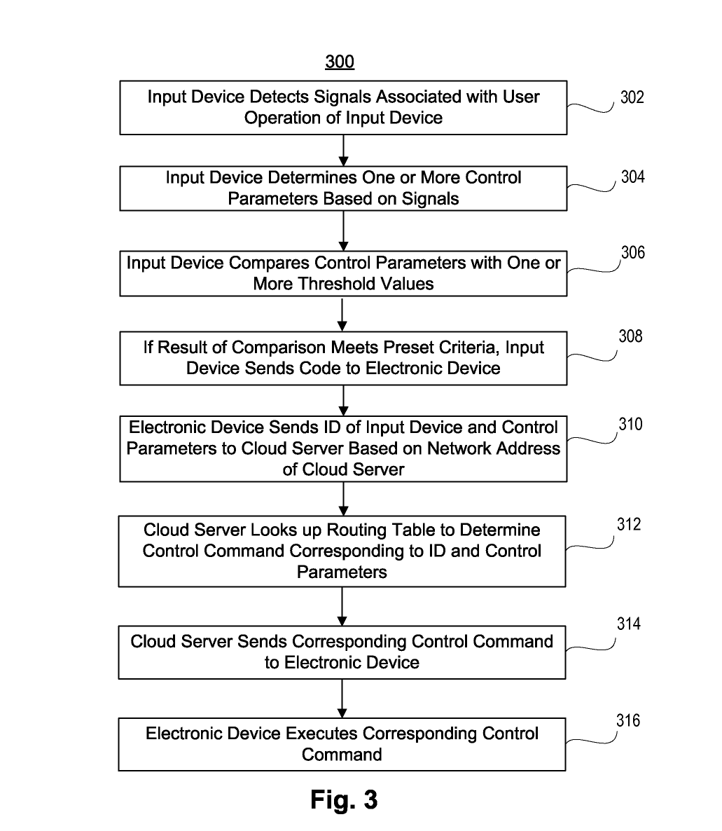

FIG. 3 is a flowchart of an input method 300, according to an exemplary embodiment. For example, the method 300 may be used in the system 100. Referring to FIG. 3, the method 300 includes the following steps.

In step 302, the input device 140, through the sensor component 142, detects signals associated with a user operation of the input device 140. The signals may be based on light reflected from a physical surface while the input device 140 is moving on the surface, in the case of an optical mouse, or based on the movement of a mouse ball rolling on the surface, in the case of an analog mouse. The signals may also be based on the user's manipulation of buttons, switches, touch pads, etc., associated with the input device 140.

In step 304, the input device 140, through the processing component 144, determines one or more control parameters based on the signals. The control parameters may be motion parameters descriptive of a motion of the input device 140, including moving speed, acceleration, deceleration, moving direction, moving trajectory, moving frequency, or any combination thereof. The control parameters may also be clicking parameters descriptive of the pattern in which the buttons, switches, touch pads, etc., are clicked or otherwise manipulated, including time duration of a clicking event, frequency of clicking events in a given time period, time interval between two successive clicking events, pattern of clicking events among a combination of multiple buttons, switches, touch pads, etc., or any combination thereof.

In step 306, the input device 140 compares the control parameters with one or more threshold values. The threshold values are stored in the memory 146. If the comparison result meets preset criteria, step 308 will be executed. Otherwise, the method 300 is terminated. For example, a threshold value may be the frequency of moving in a certain direction within a set period of time. The corresponding criteria may be whether the moving frequency is equal to or exceeds 3 times. As another example, a threshold value may be the duration over which a button is clicked. The corresponding criteria may be whether the clicking time is longer than 3 seconds but short than 4 seconds. By comparing the control parameters to the criteria, the input device 140 can filter and categorize the user inputs and reduce false responses due to noise or unintended inputs. For example, if the input device 140 is configured to generate input information based on motions of the input device 140, step 306 can ensure the input device 140 to only respond to those motions conforming to the preset criteria, and therefore can enhance the user experience.

In step 308, if a result of the comparison meets the preset criteria, the input device 140 sends a code to the electronic device 120. The code may include an identifier (ID) of the input device 140, the control parameters, and a network address of the cloud server 160. The ID and network address may be preset or pre-stored in the memory 146, e.g., by the manufacturer of the input device 140.

In step 310, the electronic device 120 sends the ID of the input device 140 and the control parameters to the cloud server 160 based on the network address.

In step 312, the cloud server 160 looks up a routing table to determine a control command corresponding to the ID and the control parameters. The routing table is stored in the cloud server 160 and tabulates a corresponding relationship among the IDs of input devices, control parameters, and control commands. Based on the received ID and control parameters, the cloud server 312 determines the corresponding control command in the routing table. The control command may include instructions for the electronic device 120 to perform one or more tasks, such as launching an application, e.g., an Internet browser, loading a webpage in the Internet browser, displaying a message, etc.

In an exemplary embodiment, the routing table is editable. That is, one or more of the IDs, control parameters, and control commands in the routing table can be changed. This way, the operator of the cloud server 160 and/or the user of the input device 140 can choose which control commands are executed in response to a given user input.

In step 314, the cloud server 160 sends the corresponding control command to the electronic device 120.

In step 316, the electronic device 120 executes the corresponding control command.

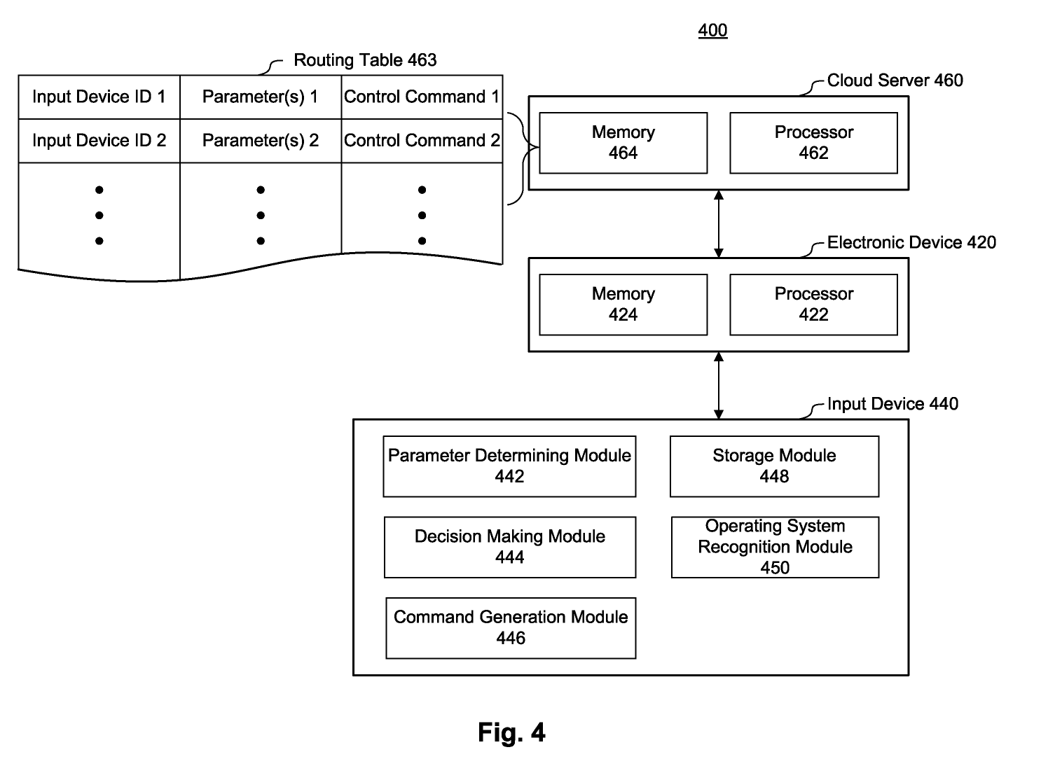

FIG. 4 is a schematic diagram illustrating an example of implementing the method 300, according to an exemplary embodiment. Referring to FIG. 4, the method 300 is performed by a system 400 including an electronic device 420, an input device 440, and a cloud server 460.

The input device 440 includes one or more of a parameter determining module 442, a decision making module 444, a command generation module 446, a storage module 448, and an operating system recognition module 450. The parameter determining module 442 is configured to determine the control parameters based on the signals collected by the input device 440. The control parameters may include, e.g., the motion parameters and/or the clicking parameters. The decision making module 444 is configured to compare the control parameters with the threshold values stored in the storage module 448, and to determine whether the comparison result meets preset or pre-stored criteria. If the comparison result meets the criteria, the decision making module 444 triggers the command generation module 446 to generate a code including the ID of the input device 440, the control parameters, and the network address of the cloud server 460. The ID and the network address are both retrieved from the storage module 448. The operating system recognition module 450 is configured to determine the operating system (e.g., version of Mac, Windows, Android, iOS, etc.) used by the electronic device 420. For example, when the input device 440 is initially connected to the electronic device 420 or at other predefined moments, the operating system recognition module 450 may sends a query to the electronic device 420, which may then respond with a message specifying the version of the operating system. Alternatively, the operating system may be explicitly or implicitly indicated by, e.g., the ID, network address, control parameters, or other information provided by the input device. The command generation module 446 is configured to send the code suitable for the operation system to the electronic device 420.

The electronic device 420 sends the ID of the input device 440 and the control parameters to the cloud server 460 based on the network address. Referring to FIG. 4, the cloud server 460 may include a processor 462 and a memory 464. Memory 464 may store one or more editable routing tables 463. Routing table 463 may indicate a corresponding relationship among IDs of input devices, control parameters, and control commands.

For example, when the control parameters indicate that the input device 440 moves in a trajectory of a circle within a certain time, the corresponding control command may include instruct the electronic device 420 to open an Internet browser and load a webpage at a certain uniform resource locator (URL), which may be included in the instruction. This way, the user of the electronic device 420 can visit a certain website by simply moving the input device 440 in the prescribed manner, saving the trouble of manually opening the browser and typing the URL into the browser.

As another example, when the control parameters indicate that a left button of the input device 440 is clicked for a certain time duration, e.g., below 2 seconds, the corresponding control command may instruct the electronic device 420 to open the Internet browser with a blank page. When the time duration is, e.g., above 3 seconds but below 4 seconds, the corresponding control command may instruct the electronic 420 to directly visit a pre-selected social networking website. And when the time duration is above 5 seconds, the corresponding control command may instruct the electronic device 420 to directly access a cloud database, e.g., Amazon Cloud Drive, or a Web service, e.g., Yahoo! Pipes. To allow the user to more preciously control the clicking duration, the input device 440 may include a time display or a group of LED lights to indicate the elapsed time.

As another example, when the control parameters indicate that input device 440 has been in use for a certain amount of time, the corresponding control command may instruct the electronic device 420 to display a prompt through a webpage or a pop-up window, inviting the user to participate in an online lottery or other contest. The user may accept the invitation to participate in the lottery using a certain input, e.g., by swinging the input device 440 between the right and the left 3 times within 2 seconds. The corresponding control command may then instruct the electronic device 420 to display a two-dimensional quick response (QR) code that encodes a coupon, a merchandise voucher, virtual cash, etc. The user can use a smart phone to scan the QR code and subsequently use the award.

The routing table 463 can be dynamically edited as needed. Certain control commands may be activated or deactivated by adding or deleting them from the routing table. For example, if the above described online lottery offer expires, the operator of the cloud server 460 can remove the corresponding control commands from the routing table 463. Alternatively, the webpage or pop-up window may contain a menu for the user of the input device 440 to deactivate the lottery if the user does not want to participate.

The control commands that correspond to a particular input device 440 may also be changed. For example, if the operator of the cloud server 460 only wants a selected group of input devices 440 to participate in the above described lottery, the operator can restrict the lottery control commands to the IDs of the selected input devices 440.

Moreover, the priority of each control command may be adjusted by changing the corresponding control parameters in the routing table 463. For example, if the routing table 463 initially defines that certain control command is executed if the moving speed of the input device 440 is above x m/s but below y m/s, the operator of the cloud server 460 may decrease the value of x and increase the value of y so that the control command may be more easily executed.

Referring to FIG. 4, the processor 462 may be configured to look up the routing table 463 to determine the corresponding control command based on the ID of the input device 440 and the control parameters. The processor 462 then sends the corresponding control command to the electronic device 420. As shown in FIG. 4, the electronic device 420 may include a processor 422 and a memory 424. The processor 422 may be configured to execute the control commands, such as loading a webpage. The memory 424 stores instructions and data needed by the processor 422 to execute the corresponding control commands.

Consistent with the above description, the implementation of the method 300 may not require the electronic device to be installed with a specific application or driver program, in particular where the cloud server stores and looks up the routing table. In some embodiments, the routing table is stored in the electronic device or the input device, and thus the cloud server is not required to implement an input method consistent with the method 300. In these embodiments, specific applications or driver programs may be installed in the electronic device or input device to facilitate the implementation of the input method.

One of ordinary skill in the art will understand that the above-described modules can each be implemented by hardware, or software, or a combination of hardware and software. One of ordinary skill in the art will also understand that multiple ones of the above-described modules may be combined as one module, and each of the above-described modules may be further divided into a plurality of sub-modules.

In exemplary embodiments, the entries in the routing table may be changed based on the practical need. For example, the routing table may not need to include the ID of the input device if the control commands are intended to be indiscriminately applied to all the input devices. For another example, the routing table may include additional entries, such as the type of the input device, the ID of sets and/or subsets of input devices, or the ID of individual devices, to further differentiate the input devices from one another.

Consistent with the disclosed embodiments, the input device may be configured to generate input information solely based on motions of the input device or other objects detectable by the input device. For example, if the input device is a mouse, a user can control the electronic device by simply moving the mouse, without clicking any buttons.

For example, during actual implementation, the manufacturer of the mouse or a third party service provider may create rules specifying the corresponding relationships between various motions of the mouse and control commands. For example, such rules may prescribe that swing the mouse between the right and the left 3 times within 2 seconds will cause the electronic device to open a webpage. These rules may be printed in the mouse menu or displayed by the mouse's driver program so that a user can know how to use the mouse. These rules may also be stored in the cloud server or the electronic device as an editable routing table. The manufacturer, the service provider, and/or the user may change the rules by editing the routing table at any time. For example, the service provider may periodically change the webpage URL so that the user will visit different webpages now and then.

The mouse can detect and analyze its moving speed, acceleration, deceleration, moving direction, moving trajectory, moving frequency, or any combination thereof. For example, the mouse may determine whether these motion parameters indicate a swing motion between the right and the left 3 times within 2 seconds. If the determination result is positive, the motion parameters will be used by the electronic device and/or the cloud server to look up the corresponding webpage to be visited. Therefore the mouse can be used to directly access a specific webpage in a clickless way. This makes visiting webpages a quick, easy, and interesting experience. Moreover, the addresses of the visited webpages can be dynamically configured.

The present disclosure provides an input method and device that are efficient, flexible, and interactive. By establishing connections between the control parameters and the control commands, the user of the input device can quickly and conveniently launch desired operations. This improves the efficiency of human-machine interaction and makes the use of the input device an interesting experience. Moreover, because the routing table may be dynamically edited, the input devices can be customized to initiate various operations as needed. Furthermore, because third parties, such as service providers, merchants, or input device manufactures, can provide input to and/or manage the routing table, they can use the input device to more directly interact with the users of the input devices. Thus, the commercial value of the input devices is drastically increased.

This application is intended to cover any variations, uses, or adaptations of the present disclosure following the general principles thereof and including such departures from the present disclosure as come within known or customary practice in the art. Other embodiments of the present disclosure will be apparent to those skilled in the art from consideration of the specification and practice of the present disclosure. It is intended that the specification and examples be considered as exemplary only, with a true scope and spirit of the invention being indicated by the following claims.

In particular, variations of the disclosed methods will be apparent to those of ordinary skill in the art, who may rearrange and/or reorder the steps, and add and/or omit certain steps without departing from the spirit of the disclosed embodiments. Non-dependent steps may be performed in any order, or in parallel.

What is claimed is:

1. A mouse for use with a computer, comprising:
one or more sensors configured to detect a user action on the mouse; and
a command generator configured to transmit signals to the computer, the signals causing the computer to:
determine a predefined destination in response to the user action, wherein the predefined destination may change over time; and
present information at the predefined destination to the user.

2. The mouse of claim 1, wherein the destination is stored in a routing table.

3. The mouse of claim 2, wherein the routing tables indicates a corresponding relationship between one or more user actions and one or more predefined destinations.

4. The mouse of claim 2, wherein the computer send the signals and an ID of the mouse to a cloud server communicatively connected to the computer, the signals further causing the cloud server to look up the routing table to determine the predefined destination based on the user action and the ID.

5. The mouse of claim 1, wherein the predefined destination comprises a webpage, a Web service, or a database.

6. The mouse of claim 1, further comprising a decision maker configured to:
compare the user action with a threshold condition; and
if a result of the comparison meets predefined criteria, trigger the command generator to generate the signals.

7. The mouse of claim 1, wherein the user action comprises at least one of clicking the mouse or moving the mouse.

8. The mouse of claim 1, wherein the signals indicates at least one of a moving speed, an acceleration, a deceleration, a moving direction, a moving frequency, a moving trajectory, a moving frequency, a clicking time duration, a clicking frequency, or a clicking pattern of the mouse.

9. A mouse for accessing a predefined destination in a click-less way, the mouse comprising:
one or more sensors configured to detect a motion of the mouse; and
a command generator configured to transmit signals to a computer, the signals causing the computer to access the predefined destination;
wherein neither clicking on the mouse nor typing an address of the predefined destination is required to access the predefined destination.

10. The mouse of claim 9, wherein the detected motion comprises one or more of a moving speed, an acceleration, a deceleration, a moving direction, a moving frequency, a moving trajectory, a moving frequency, a clicking time duration, a clicking frequency, or a clicking pattern of the mouse.

11. The mouse of claim 9, wherein the predefined destination changes over time.

12. The mouse of claim 9, wherein the destination is stored in a routing table.

13. The mouse of claim 12, wherein the routing tables indicates a corresponding relationship between one or more motions of a mouse and one or more predefined destinations.

14. The mouse of claim 12, wherein the routing table is editable.

15. The mouse of claim 12, wherein the signal further cause:
the computer to send the signals and an ID of the mouse to a cloud server communicatively connected to the computer; and
the cloud server to look up the routing table to determine the predefined destination based on the user action and the ID.

16. The mouse of claim 9, wherein the predefined destination comprises a webpage, a Web service, or a database.

17. The mouse of claim 9, further comprising a decision maker configured to:
compare the motion of the mouse with a threshold motion; and
if a result of the comparison meets predefined criteria, trigger the command generator to generate the signals.

18. The mouse of claim 9, wherein:
the mouse is assigned an ID; and
the signals are further configured to cause the computer to access the predefined destination based on the ID.

19. An input device for use with an electronic device, comprising:
one or more sensors configured to detect a user action; and
a command generator configured to transmit signals to the electronic device to:
initiate a determination of a predefined response to the user action, wherein information of the predefined response is stored in a routing table; and
cause the electronic device to present the predefined response to the user.

20. The input device of claim 19, wherein the routing table indicates at least a corresponding relationship between one or more predefined responses and one or more user actions.

21. The input device of claim 19, the routing table is editable.

22. The input device of claim 19, further comprising a decision maker configured to:
compare the user action with a threshold condition; and
if a result of the comparison meets predefined criteria, trigger the command generator to generate the signals.

23. The input device of claim 19, wherein the input device is one of a mouse, a remote control, a touch pad, a touch screen, a track ball, or a human gesture recognition device.

24. The input device of claim 19, wherein the electronic device is one of a computer, a tablet, a smart phone, a smart TV, or a personal digital assistant.

25. The input device of claim 19, wherein the user action comprise at least one of:
causing a motion of the input device;
causing a motion of an object detected by the input device; or
clicking one or more buttons of the input device.

26. The input device of claim 19, wherein the predefined response comprises at least one of:
accessing a webpage;
displaying a promotion message; or
connecting to a merchant's database.

27. The input device of claim 19, wherein the determination of the predefined response to the user action is implemented by the input device, the electronic device, or a cloud server communicatively connected to the electronic device via a network.

28. The input device of claim 19, wherein the electronic device send the signals and an ID of the mouse to a cloud server communicatively connected to the electronic device, the signals further causing the cloud server to look up the routing table to determine the predefined destination based on the user action and the ID.

29. The input device of claim 19, the signals indicates at least one of a moving speed, an acceleration, a deceleration, a moving direction, a moving frequency, a moving trajectory, a moving frequency, a clicking time duration, a clicking frequency, or a clicking pattern of the mouse.

30. An input device for use with an electronic device, comprising:
one or more sensors configured to detect a motion of the input device;
a decision maker configured to compare the detected motion with a threshold condition; and
a command generator configured to, if a result of the comparison meets predefined criteria, generate signals cause the electronic device to connect to a predefined destination.

31. The input device of claim 30, wherein:
the input device is assigned an ID; and
the signals are further configured to cause the electronic device to connect to the predefined destination based on the ID.

32. The input device of claim 30, wherein the detected motion comprises one or more of a moving speed, an acceleration, a deceleration, a moving direction, a moving trajectory, or a moving frequency of the input device.

33. The input device of claim 30, wherein the predefined destination comprises a webpage, a Web service, or a database.

34. The input device of claim 30, wherein the input device is one of a mouse or a remote control.

35. The input device of claim 30, wherein the electronic device is one of a computer, a tablet, a smart phone, a smart TV, or a personal digital assistant.

36. A method of an input device in communication with an electronic device, comprising:
detecting a user action;
initiating a determination of a predefined response to the user action, wherein information of the predefined response is stored in a routing table; and
causing the electronic device to present the predefined response to the user.

37. The method of claim 36, wherein the routing table indicates at least a corresponding relationship between one or more predefined responses and one or more user actions.

38. The method of claim 36, the routing table is editable.

39. The method of claim 36, wherein initiating the determination of the predefined response to the user action further comprises:
comparing the user action with a threshold condition; and
if a result of the comparison meets predefined criteria, initiating the determination of the predefined response to the user action.

40. The method of claim 36, wherein the input device is one of a mouse, a remote control, a touch pad, a touch screen, a track ball, or a human gesture recognition device.

41. The method of claim 36, wherein the electronic device is one of a computer, a tablet, a smart phone, a smart TV, or a personal digital assistant.

42. The method of claim 36, wherein the user action comprise at least one of:
causing a motion of the input device;
causing a motion of an object detected by the input device; or
clicking one or more buttons of the input device.

43. The method of claim 36, wherein the predefined response comprises at least one of:
accessing a webpage;
displaying a promotion message; or
connecting to a merchant's database.

44. The method of claim 36, wherein the determination of the predefined response to the user action is implemented by the input device, the electronic device, or a cloud server communicatively connected to the electronic device via a network.

45. The method of claim 36, wherein the determination of a predefined response to the user action comprises:
sending signals descriptive of the user action and an ID of the mouse to a cloud server communicatively connected to the electronic device; and
looking up, by the cloud server, the routing table to determine the predefined destination based on the user action and the ID.

46. The method of claim 36, the signals indicates at least one of a moving speed, an acceleration, a deceleration, a moving direction, a moving frequency, a moving trajectory, a moving frequency, a clicking time duration, a clicking frequency, or a clicking pattern of the mouse.

47. A method of an input device in communication with an electronic device, comprising:
detecting a motion of the input device;
comparing the detected motion with a threshold condition; and
if a result of the comparison meets predefined criteria, connecting to a predefined destination.

48. The method of claim 47, wherein:
the input device is assigned an ID; and
connecting to the predefined destination further comprises connecting to the predefined destination based on the ID.

49. The method of claim 47, wherein the detected motion comprises one or more of a moving speed, an acceleration, a deceleration, a moving direction, a moving trajectory, or a moving frequency of the input device.

50. The method of claim 47, wherein the predefined destination comprises a webpage, a Web service, or a database.

51. The method of claim 47, wherein the input device is one of a mouse or a remote control.

52. The method of claim 47, wherein the electronic device is one of a computer, a tablet, a smart phone, a smart TV, or a personal digital assistant.
